(19) United States
(12) Patent Application Publication
(10) Pub. No.: US 2006/0162522 A1
(43) Pub. Date: Jul. 27, 2006

(54) Cutting machine for cutting elongated products

(75) Inventors: Mario Gioni Chiocchetti, Capannori, Lucca (IT); Mauro Gelli, Capannori, Lucca (IT)

Correspondence Address: BREINER & BREINER, L.L.C., P.O. BOX 19290, ALEXANDRIA, VA, 22320-0290, US

(73) Assignee: Fabio Perini S.p.A., Lucca (IT)

(21) Appl. No.: 10/520,504

(22) PCT Filed: Jul. 2, 2003
(86) PCT No.: PCT/IT03/00417

§ 371 Date: Jan. 7, 2005

(30) Foreign Application Priority Data
Jul. 9, 2002 (IT) FI2002A000123

(51) Int. Cl. B23D 19/00

(52) U.S. Cl. 83/471

(57) ABSTRACT

The cutting machine comprises at least one path for the products to be cut (L); at least one device (3, 5, 9) for feed of the products along said path, according to a direction of feed (fL); an element (17) rotating around a main axis of rotation (A-A); on said rotating element, at least one disk-shaped blade (19A, 19B, 19C) rotating around its own axis of rotation (B-B), said blade being provided with alternate translatory motion, substantially parallel to the direction of feed. The disk-shaped blades moves axially in relation to the rotating element during rotation of said rotating element. Moreover, the translatory movement of the disk-shaped blade is controlled so that it moves in the same direction as the direction of feed of the products to be cut when the blade is engaged in said products to follow the feed of the products during cutting. Motion in the opposite direction to the direction of feed of the products is imparted on the blade in a period of time in which the blade is disengaged from said products.

### TECHNICAL FIELD

The present invention relates to a cutting machine for cutting elongated products, in particular for cutting logs of wound web material to obtain small rolls with limited axial dimensions in relation to the length of the initial logs.

### STATE OF THE ART

Cutting machines are commonly utilized in the paper converting industry to produce small rolls from logs of wound paper, with a multiple axial length in relation to the axial length of the finished product, corresponding to the axial dimension of the reels of paper supplied by paper mills.

Cutting machines commonly used to cut logs of paper or other wound web material are provided with an element rotating around an axis usually parallel to the direction of feed of the logs to be cut. These are fed along one or more channels parallel to one another to be subjected to the action of a rotating disk-shaped cutting blade carried by the rotating element. The disk-shaped blade rotates around an axis in turn parallel to the axis of rotation of the rotating element and to the direction of feed of the elongated products to be cut. Traditionally, machines of this type have intermittent feed of the logs, which stop before the rotating disk-shaped blade enters the material to perform the cut. This means that each log is made to advance and stopped several times in order to be cut into the established number of small rolls.

Machines of this type have some problems linked to productivity and other problems caused by phenomena of inertia produced by the repeated stops to which the log is subjected before each cutting operation.

To solve these problems it has been suggested (see U.S. Pat. No. 3,213,731) to feed the roll or log, or other elongated product, at a fixed speed and to move the rotating element carrying the disk-shaped cutting blade with alternate translatory motion parallel to the direction of feed of the logs. Forward and backward movement of the rotating element is synchronized with the angular position of said element, so that the rotating disk-shaped blade is made to advance in the same direction as the elongated product to be cut during the period of time in which the blade is engaged in the material to be cut. When the blade is positioned out of the material the rotating element is moved backwards together with the rotating blade to the initial position to perform a subsequent cutting operation on the elongated product which continues to be fed at fixed speed.

This solution has considerable drawbacks due to the need to make the rotating element and the blade supported on it travel forwards and backwards many times, resulting in numerous accelerations and decelerations, causing considerable inertial stresses. Alternatively, to reduce these problems, the products to be cut would have to be fed at such a low speed that the use of a blade with alternate motion would no longer be cost-effective.

US-RE-30598 describes a cutting machine to cut elongated products, particularly logs of wound web material, which attempts to solve the problem described hereinbefore using a different approach. In this case the rotating element carrying the disk-shaped cutting blades is supported on a shaft with an axis of rotation skew in relation to the direction of feed of the logs to be cut. The rotating disk-shaped blades are disposed on this rotating element with their axis of rotation parallel to the direction of feed of the logs. A complicated mechanical system maintains the parallelism of the axes of rotation of the disk-shaped blades in relation to the log or logs being fed in the feed channels.

With this arrangement each rotating disk-shaped cutting blade has—in a projection on the horizontal plane of feed of the logs—a component of translatory velocity parallel to the axis of the logs and with a sinusoidal trend, that is with a cyclically variable modulus with each turn of the rotating element. Each disk-shaped blade therefore more or less follows the feed movement of the logs during cutting. Nonetheless, while the logs are fed at a fixed speed, the blade engaged in the logs during cutting advances with a sinusoidal speed. This gives rise to a considerable tracking error between the blade and the log, that is a difference between the feed speed of the logs and the component parallel to it of the speed of the rotating blades. This error greatly limits functionality of the machine and the speed it is able reach.

In the effort to correct this defect, US-RE-30598 proposes a cam mechanism that causes a translatory movement of each rotating disk-shaped blade in relation to the rotating element carrying it. The velocity component of the blade rotating parallel to the direction of feed of the logs caused by inclination of the axis of the rotating element is added to the component caused by alternate translation of the blade in relation to the rotating element in the attempt to obtain—for the whole time the blade is engaged in the log to be cut—an essentially equal blade and log speed. For this purpose it is necessary to utilize, on the rotating element, a control cam in turn rotating and the profile of which imparts alternate motion in both directions on the respective blade during the short period of time in which the blade is engaged in the material to be cut.

The solution described hereinbefore is extremely complex and has not been adopted in practice.

EP-B-0507750 describes a cutting machine wherein the rotating element carrying the disk-shaped cutting blade is again provided with alternate motion according to a direction parallel to the direction of feed of the logs and parallel to the axis of rotation of the disk-shaped blade carried by the rotating element. However, unlike U.S. Pat. No. 3,213,731, in this case the logs of wound web material are fed with a variable speed, so that during the cut their speed may be reduced in relation to the feed speed between one cut and the next cut. In this way it is possible to attain the dual advantage on the one hand of reducing the forward and backward travel of the rotating element (and therefore the relative inertial stresses) and on the other of reaching a high level of flexibility on the machine. In fact, simply by varying the feed speed of the logs between one cut and the next cut it is possible to modify the length of the small rolls obtained by cutting the elongated products. With this system high hourly production rates are attained and the defects and limits of machines with intermittent feed of the logs are substantially eliminated. The mechanical structure is simple and easy to control.

EP-B-0609668 describes a machine with a similar concept to the machine in US-RE-30598, wherein the rotating element rotates around an axis skew in relation to the direction of feed of the logs. By feeding these at a variable speed in the same way described in EP-B-0507750 the same advantage described in this document is attained, that is a high level of flexibility in terms of length of the product obtained. As it is possible to vary the feed speed of the logs during cutting it is automatically also possible to correct the error between the feed speed of the log and the feed speed of the rotating disk-shaped blade.

Prior art machines are provided with one or at the most two disk-shaped cutting blades, which substantially limits the productivity of the machine.

In fact, even with two disk-shaped cutting blades it is not possible to reach particularly high production rates, as it is not possible to increase the rotation speed of the rotating element beyond a certain limit. Particularly high speeds damage the product to be cut due to the high impact exerted by the blade on the material during penetration. Moreover, problems of inertia are caused, emphasized by the particular geometries of the machines.

### OBJECTS AND SUMMARY OF THE INVENTION

The object of the present invention is to produce a cutting machine for elongated products, especially although not exclusively logs of wound web material, which overcomes the drawbacks of traditional machines. In greater detail, the object of the present invention is to produce a machine with a particularly simple arrangement and structure which can attain high levels of production flexibility and high production rates.

Substantially, according to the invention this and other objects, which shall become clear to those skilled in the art by reading the text hereunder, are obtained with a cutting machine of the type comprising: at least one path for products to be cut; at least one device to feed the products along said path, according to a direction of feed; an element rotating around a main axis of rotation; on said rotating element, at least one disk-shaped blade rotating around its own axis of rotation, said blade being provided with alternate translatory motion, substantially parallel to the direction of feed.

Characteristically, according to the invention the disk-shaped blade moves axially in relation to the rotating element during rotation of said rotating element, and the translatory movement of the disk-shaped blade is controlled so that it moves in the same direction as the direction of feed of the products to be cut when the blade is engaged in said products to comply with the feed of the products during cutting, the motion in the opposite direction to the direction of feed of the products being imparted on said blade in a period of time in which the blade is disengaged from said products.

Contrary to prior art cutting machines, therefore, the entire forward and backward movement of the disk-shaped blade or blades in the direction of feed of the products to be cut is imparted only on the blade and relative supporting means, while the rotating element remains in a fixed position in relation to said direction. Unlike US-RE-30598, the alternate movement of the blade or blades in relation to the rotating element is not required to correct a difference between the feed speed of the blade and the difference between the feed speed of the product during cutting, but to obtain forward and backward movement of the blade.

This results in an extremely simple structure, that also makes it possible to position a greater number of disk-shaped blades on the rotating element to those normally provided on this type of machine. For example, three disk-shaped blades staggered angularly by 120° may be provided. In this way the machine can reach an extremely high hourly productivity maintaining a relatively low rotation speed of the rotating element, with consequent advantages both in terms of dynamic stresses on the machine parts and in quality of cut. This is possible thanks to the reduced impact speed of the blade on the product at the beginning of the cut.

In practice, as the alternate movement of the blade in the direction of feed of the product to be cut is obtained by translating the blade and its support in relation to the rotating element, the main axis of rotation of the rotating element and the axis of rotation of the disk-shaped blade or blades may advantageously be parallel to each other and to the direction of feed of the products to be cut. This makes the machine even more simple from a mechanical viewpoint.

According to an advantageous embodiment, each disk-shaped blade is carried by a respective sleeve sliding axially in a corresponding seat of the rotating element. When periodic sharpening of the disk-shaped blade or blades is necessary, a sharpening unit of the respective disk-shaped blade may be provided integral with each of said sleeves, said sharpening unit translating with an alternate motion integral with the corresponding disk-shaped blade. Wear on the blade may be compensated by moving the grinding wheel or wheels of the sharpening unit towards or away from the blade with the movement parallel to their axis, rather than orthogonal to the axis of the blade, making the sharpening unit particularly simple, light and inexpensive to construct.

The alternate translatory movement of each disk-shaped blade may be controlled in any appropriate way, for example even via individual actuators associated with each blade. Nonetheless, according to a preferred and particularly simple embodiment of the invention, each of the supporting sleeves of the disk-shaped cutting blades is operated in its alternate motion by a common cam component, fixed to the structure of the machine. In this case, for example, each of said sleeves may have a feeler cooperating directly with said common cam. Alternatively, the common cam may transmit movement to the sleeves via respective rocker components supported by the rotating element.

According to a possible embodiment of the machine according to the invention, each sharpening unit comprises at least one grinding wheel that moves from an operating position, in contact with the cutting edge of the respective disk-shaped blade, to a position in which it is not operating, out of contact with said disk-shaped blade. The movement to move towards and away is advantageously performed in a direction parallel to the axis of the grinding wheels.

In a possible embodiment of the invention, each grinding wheel is carried by a bushing sliding axially in a support integral with the sleeve of the respective blade. The bushing may be supported in said sleeve to move angularly around its axis. Moreover, a cam mechanism may be provided between the support and the bushing to produce axial translation of the bushing when said bushing is made to rotate around its own axis. This makes it possible to obtain the movement to move the grinding wheel towards and away from the blade. The movement may be imparted by an actuator, for example a piston-cylinder, which controls the rotary movement of the bushing around its axis.

The movement of each grinding wheel parallel to its axis also makes it possible to take up the wear on the blade. In fact, as this becomes worn and its diameter decreases, the axial travel moving the grinding wheel towards the blade increases. The use of an actuator which controls rotary movement of the grinding wheel supporting unit around its axis makes it possible, simply by controlling the pressure of the fluid operating the actuator, to obtain sufficiently accurate control of the contact pressure of the grinding wheel on the blade, irrespective of the amount of wear on the blade.

This particular arrangement of the grinding wheel support and of the respective controls may also be adopted on grinding wheels of disk-shaped blades in cutting machines with a different arrangement than the one described, with analogous advantages in terms of taking up the wear and/or controlling the pressure between grinding wheel and blade. In general the grinding wheel may be motorized, as in the example described hereunder, or idle and drawn in rotation by friction with the blade. Particularly advantageous characteristics and embodiments of a sharpening unit of this type are indicated in the attached claims and described hereunder in the specific application to a cutting machine according to the invention.

According to a different aspect, the present invention relates to a cutting machine for cutting elongated products, comprising: at least one path for the products to be cut; at least one device for feeding products along said path, according to a direction of feed; an element rotating around a main axis of rotation; on said rotating element, at least one disk-shaped blade rotating around its own axis of rotation, said blade being provided with alternate translatory motion parallel to its axis during rotation of said rotating element, substantially parallel to the direction of feed; characterized in that each of said blades is operated in its alternate motion by a common cam component. The cam may impart different movements to those described above on the blades, such as a movement that changes direction while the blade is positioned inside the material to be cut. The cam is preferably fixed on a load-bearing structure, which also supports the rotating element.

### BRIEF DESCRIPTION OF THE DRAWINGS

The invention will be better understood by following the description and attached drawing, which show a non-limiting practical example of the invention. In the drawing:

FIG. 1 shows a summary side view of a cutting machine according to the invention;

FIG. 2 shows a front view according to II-II in FIG. 1;

FIG. 2A shows a plan view of the control cam in FIG. 2;

FIG. 3 shows a partly sectional side view according to III-III in FIG. 2;

FIG. 4 shows a side view of the rotating element in a modified embodiment;

FIGS. 5 and 6 show partly enlarged sections and view of details in FIG. 3;

FIG. 7 shows an axial section of a grinding wheel and relative motorized movement system for moving it towards and away from the disk-shaped cutting blade; and

FIG. 8 shows a partly sectional view according to VIII-VIII in FIG. 7.

### DETAILED DESCRIPTION OF THE PREFERRED EMBODIMENTS OF THE INVENTION

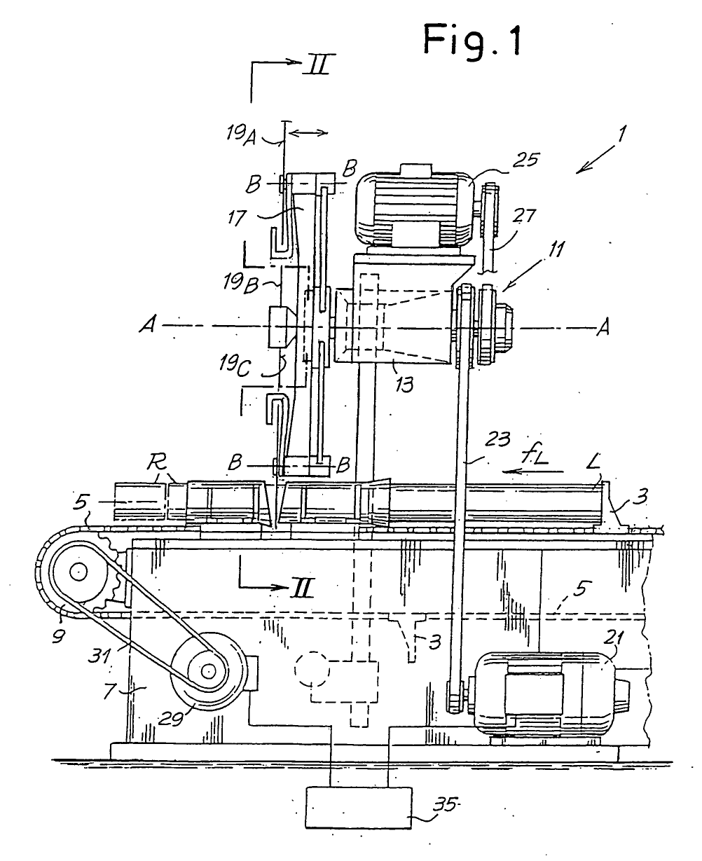

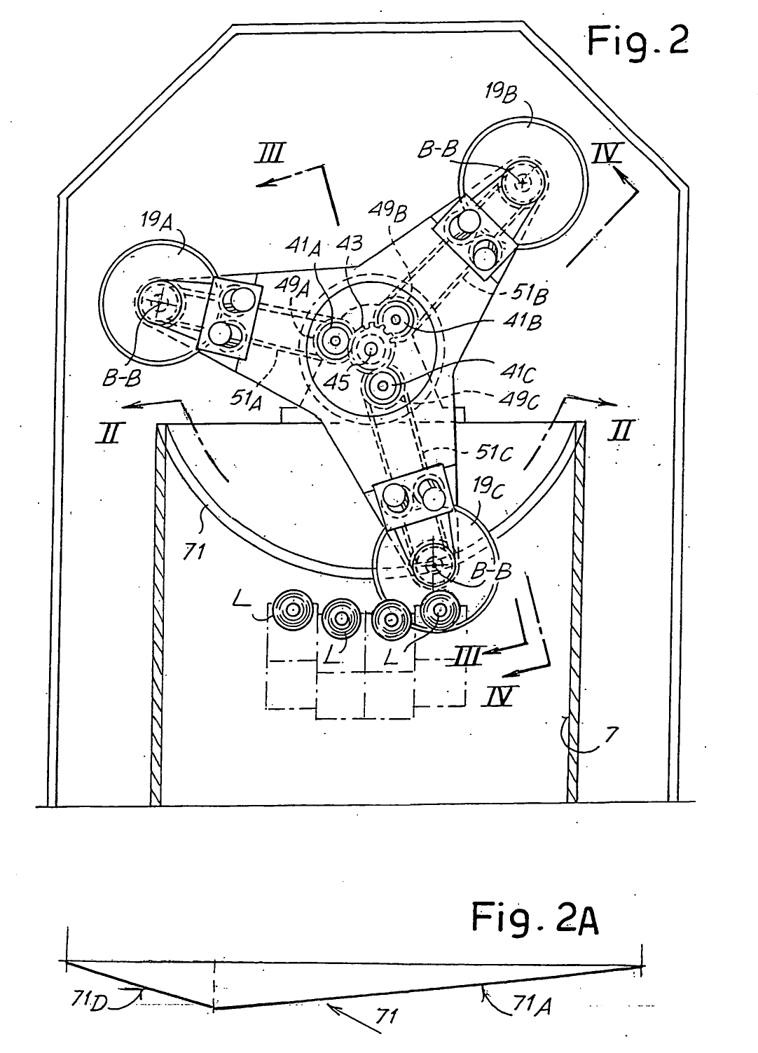

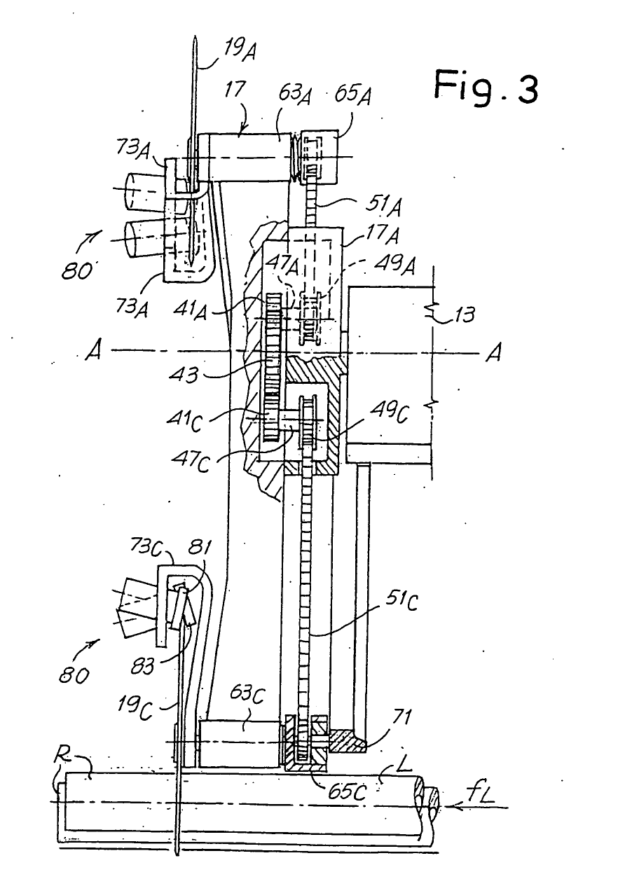

FIG. 1 schematically shows (limited to its front part) the cutting machine as a whole, indicated with 1. The machine has a feed path for the logs to be cut, indicated with L, which are pushed by pushers 3 connected to a flexible chain component or similar 5, driven around a guide wheels supported by a fixed structure 7. FIG. 1 shows a single guide wheel, indicated with 9, while the other, not shown, is positioned at the rear end of the cutting machine. In actual fact, as can be clearly seen in FIG. 2 and as is known from the prior art, the flexible components 5 are more than one in parallel to feed several rows of logs L along parallel paths. In the example shown four channels are provide for simultaneous feed of four logs L positioned side by side.

The flexible components 5 associated with the various parallel feed channels of the logs may be motorized separately from one another to stagger movement of the logs in the individual feed channels.

The number 11 generically indicates a cutting head which via a support 13 carries a rotating element 17. The element 17 rotates around a horizontal axis A-A parallel to the direction fL of feed of the logs L. Mounted on the rotating element 17 are three disk-shaped blades 19A, 19B and 19C disposed at 120° from one another around the axis A-A, as can be seen in particular in FIG. 2. Each of the rotating disk-shaped blades 19A, 19B and 19C rotates around its own axis of rotation B-B parallel to the axis A-A and to the direction of feed fL of the logs L.

The number 21 indicates a motor which, via a belt 23, transmits rotary motion to the rotating element 17. A second motor 25 is disposed on the support 13 of the rotating element 17, which via a belt 27 supplies rotary motion to a shaft that carries the rotating disk-shaped blades 19A, 19B and 19C in rotation through a transmission that shall be described hereunder. A third motor 29 carries the guide wheel 9 of the rotating component 5 in rotation via a belt 31.

As mentioned above, as several parallel channels may be provided to feed the logs L that are cut individually to form the small rolls R, a guide wheel 9 may be associated with each channel, with its own motor drive 29 appropriately controlled as a function of the angular position of the rotating element 17. The number 35 indicates a programmable control unit that synchronizes the feed movement of the flexible component or components 5 via the motor or motors 29 with the angular position of the rotating element 17 via the motor 21 control.

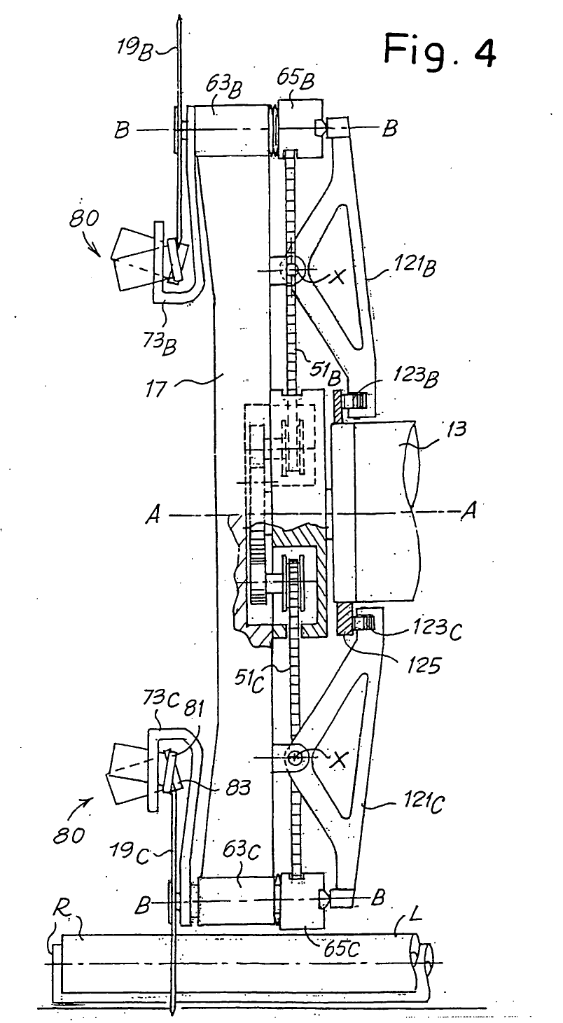

With reference to the FIGS. 2 and 3, which show a first embodiment of the machine according to the invention, these show how the rotating element 17, drawn in rotation by the hub 17A, has three toothed wheels inside it, disposed at 120° from one another around the axis A-A, indicated with 41A, 41B and 41C. Said wheels mesh with a central toothed wheel 43 keyed onto a shaft 45, which receives motion from the motor 25 through the belt 27.

The toothed wheels 41A, 41B and 41C are keyed onto respective spindles 47A, 47B and 47C onto which toothed pulleys 49A, 49B and 49C are in turn keyed. Each of the toothed pulleys 49A, 49B, 49C transmits the motion supplied by the motor 25, through toothed belts 51A, 51B, 51C, to the rotating disk-shaped cutting blades 19A, 19B and 19C.

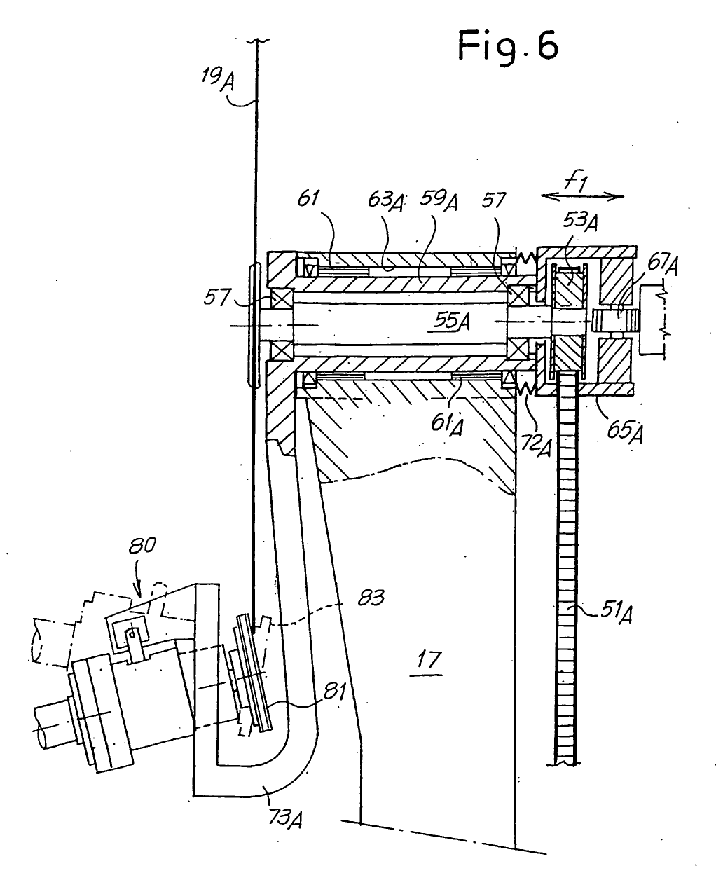

As can be seen in the detail in FIG. 5 for the blade 19C and in the detail in FIG. 6 for the blade 19A, the toothed belt 51A, 51B, 51C transmits motion to a toothed pulley 53A, 53B, 53C keyed onto an axis 55A, 55B and 55C, onto the opposite end of which the respective disk-shaped blade 19A, 19B, 19C is keyed.

Each of the shafts 55A, 55B and 55C is supported via bearings 57 in a respective sleeve 59A, 59B, 59C sliding on sliding bearings 61 mounted in a respective seat 63A, 63B, 63C produced in the rotating element 17. The angular movement around the axis B-B of each sleeve 59A, 59B, 59C is prevented by a tab 58 integral with the respective sleeve, cooperating with small wheels 60 supported idle in the sliding seat of the sleeve.

At the rear, that is on the opposite side in relation to the disk-shaped blade 19C, each sleeve 59A, 59B, 59C has an enlarged area 65A, 65B, 65C which houses the toothed pulley 53A, 53B, 53C respectively, and mounted idle on which is a small wheel 67A, 67B, 67C which constitutes the feeler for a fixed cam 71 with arc of circumference extension, shown in detail in FIG. 2 and in its plan view in FIG. 2A.

The arc of circumference along which the cam 71 extends has its own center on the axis A-A of rotation of the rotating element 17 and extends in the lower part of the path of each disk-shaped blade 19A, 19B, 119C, that is in the area in which the blade is in contact with the product to be cut.

Through the effect of the cam 71 and of the feeler 67A, 67B, 67C each sleeve 59A, 59B, 59C associated with the respective disk-shaped blade 19A, 19B and 19C translates with alternate motion according to the double arrow f1. Consequently, the respective disk-shaped blade 19A, 19B and 19C is also provided with the same motion. The movement according to the arrow f1 is parallel to the direction of feed of the logs L or other elongated products to be cut. Contact of the feeler 67A, 67B, 67C with the annular cam 71 is guaranteed by an arrangement of Belleville spring washers 72A, 72B, 72C which act between the rotating element 17 and the enlarged portion 65A, 65B, 65C of the sleeve 59A, 59B, 59C.

Along the lower arc of the circular trajectory taken by each disk-shaped blade 19A, 19B, 19C, the blade is pushed forwards by the annular cam 71 which overcomes the compression force of the respective Belleville spring washers 72A, 72B, 72C. In this way the blade which is temporarily in operation, i.e. which is inserted in the material forming the log or logs L to be cut, advances according to the feed movement of the logs L along the feed path. Advancing movement is controlled by the ascending ramp 71A of the cam 71 (see FIG. 2A). Advancing movement starts before the respective blade 19A, 19B, 19C penetrates the material forming the first of the logs to be cut, so that when it comes into contact the blade already has the same advancing speed as the feed speed of the material to be cut according to the arrow fL.

When the blade exits from the log or logs it is made to move back by the descending ramp 71D of the circular cam 71, which may be limited to an arcuate portion of the circumference followed by the feeler 67C, as in the upper stretch of travel the blade 19A, 19B or 19C does not require to follow the movement of the log. The feed movement of the logs L is controlled analogously to the description provided in EP-B-0507750.

The considerable length of the belts 51A, 51B and 51C allows the toothed pulley 53A, 53B or 53C sufficient freedom of movement in the axial direction, so that the respective disk-shaped blades may move forwards or backwards without being hampered by the mechanical transmission of motion from the central axis. The toothed pulleys 53A, 53B, 53C and 49A, 49B, 49C, may be greater in height than the respective belts 51A, 51B, 51C to allow slight slipping of the belts on the guiding pulleys.

A support 73A, 73B, 73C is integral with each sleeve 59A, 59B, 59C, each support carrying a sharpening unit 80 comprising a pair of grinding wheels 81, 83 to sharpen the respective rotating disk-shaped blades 19A, 19B, 19C. Each grinding wheel of the pair of grinding wheels 81, 83 associated with each blade acts on one of the two sides of the cutting edge of the blade. This blade may have two bevels, asymmetrical if necessary hardened on one side. For example, disk-shaped blades of the type described in WO-A-0021722 may be used.

The grinding wheels 81 and 83 may be motorized grinding wheels, that is drawn in rotation by specific motors such as pneumatic motors, although the use of grinding wheels mounted idle and drawn in rotation through the effect of the contact friction with the disk-shaped blade is not excluded. Compressed air may be fed to the actuators associated with the three pairs of grinding wheels 81, 83 by a rotating axial distributor, not shown and per se known.

The two grinding wheels 81, 83 of each pair are also provided with a movement parallel to their axis of rotation to be brought alternately into and out of contact with the respective rotating disk-shaped blade, as sharpening must not be continuous, but be performed only at regular intervals according to wear.

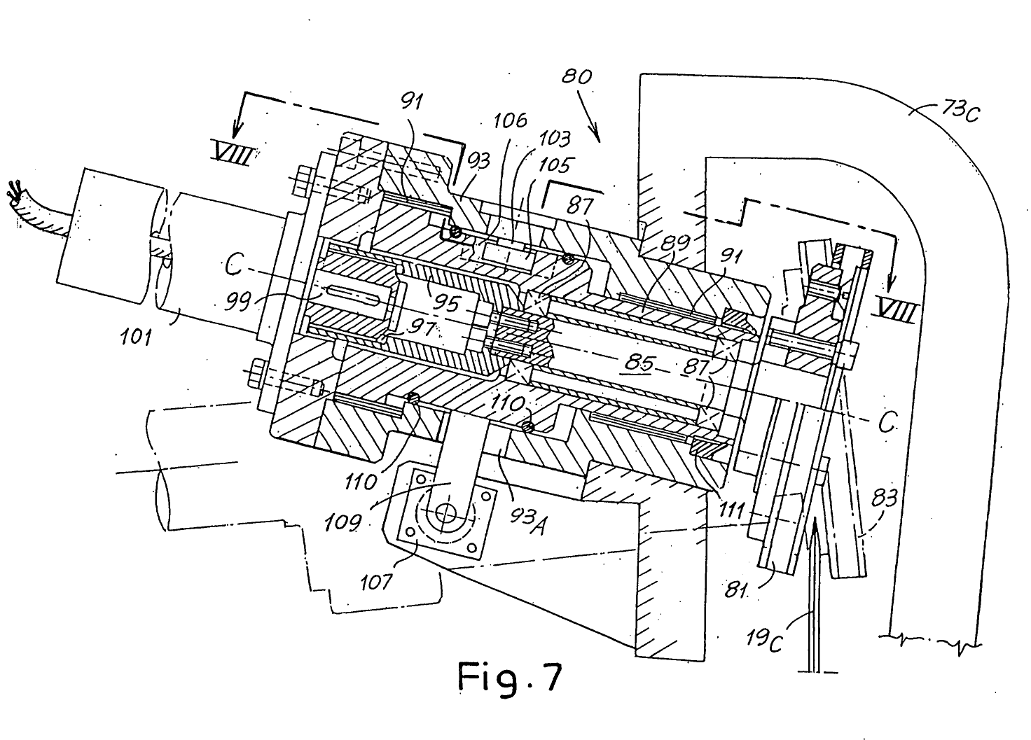

FIG. 7 shows a longitudinal section of the grinding wheel 81 and the relative supporting and axial translation and rotation system. The grinding wheel 83 is mounted in similar way.

The grinding wheel 81 is keyed onto a shaft 85 supported via bearings 87 in a bushing 89. The bushing slides on sliding bearings 91 inside a supporting sleeve 93 connected to and integral with the support 73C. At the opposite end in relation to the position of the grinding wheel 81 the shaft 85 is connected to a hollow shaft 95 coupled via a grooved coupling 97 to the motor shaft 99 of a pneumatic or equivalent motor 101.

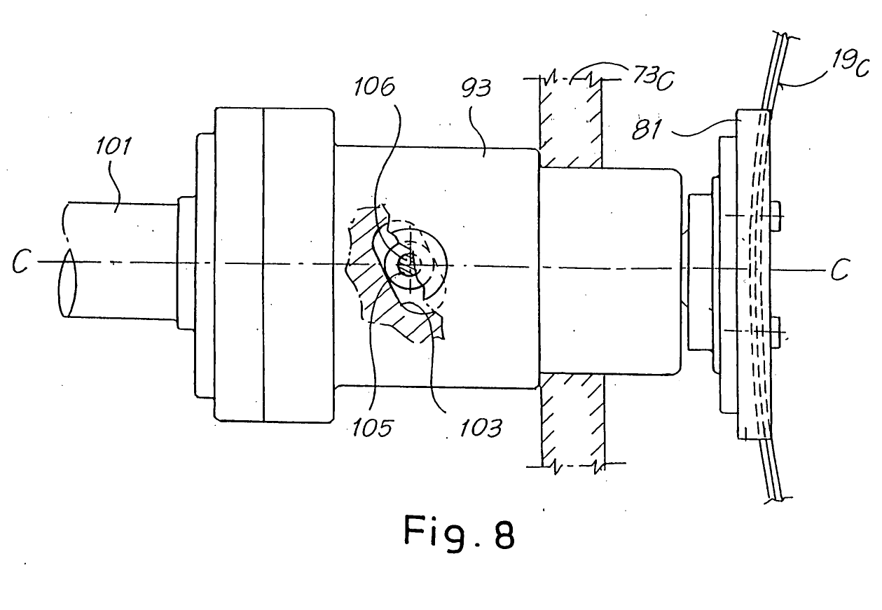

The bushing 89 has a helical groove 103 (see in particular also FIG. 8) which extends for an arc of helix extremely limited and greatly inclined in relation to the axis C-C of the shaft 85 of the grinding wheel 81. A small wheel 105 mounted idle on a spindle 106 supported by the support 93 engages in the helical groove 103.

With this arrangement angular oscillation around the axis C-C of the bushing 89 causes it to slide axially along the axis C-C through the effect of the small wheel 105, which acts as a tappet inside the helical channel 103 that performs the function of a desmodromic cam.

The angular movement around the axis C-C of the bushing 89 is imparted by a piston-cylinder actuator 107, the rod of which is connected to a bracket 109 connected to and integral with the bushing 89. Extending and withdrawing the piston-cylinder actuator 107 thus causes the grinding wheel 81 to move forwards and backwards, to be taken from a position in which it is idle to a position in contact with the respective disk-shaped blade 19A, 19B, 19C and vice versa.

With an arrangement of this type it is possible to control with great precision the pressure exerted by each of the two grinding wheels 81, 83 on the respective cutting edge of the corresponding disk-shaped blade 19A, 19B, 19C. This is obtained by controlling the pressurized fluid inside the cylinder of the piston-cylinder actuator 107. It is therefore possible to control sharpening of the blades precisely, limiting wear and at the same time maintaining optimal sharpening. With adequately hard blades it is possible to limit the variation in their diameter during their entire useful life. This makes it possible to avoid adjusting the radial position of the blades on the rotating element 17, resulting in considerable mechanical simplification in relation to prior art machines.

To allow the bracket 109 to project the support 93 has an opening 93A. To prevent dirt from penetrating the housing between the support 93 and the bushing 89 two annular seals 110, in the form of O-rings or the like, which stop dirt from penetrating through the opening 93A, and a front lip seal 111, are provided.

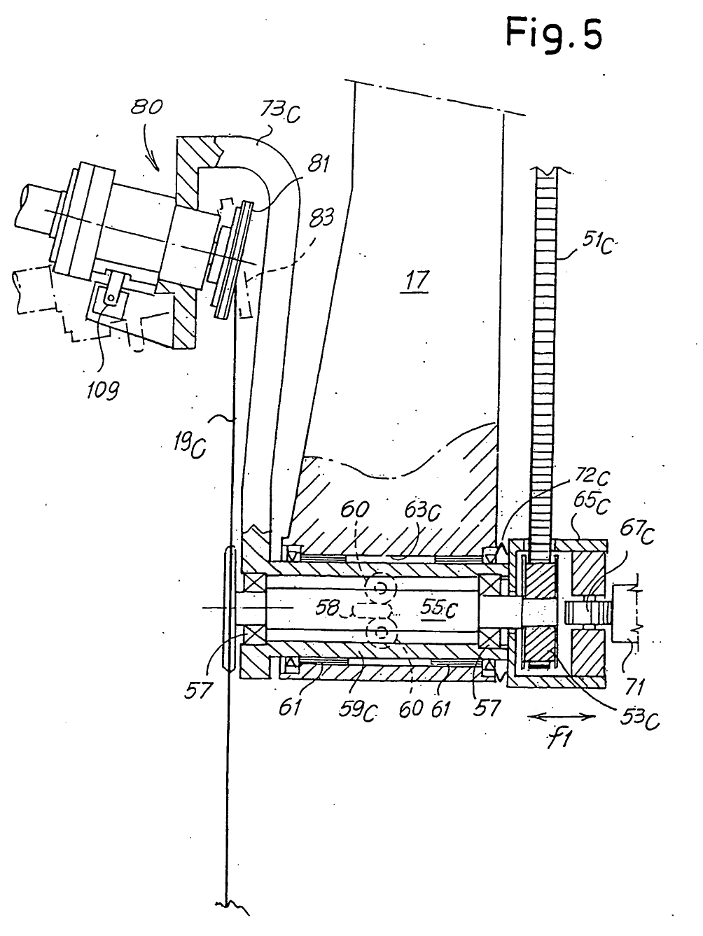

FIG. 4 shows a side view of the rotating element 17 in a second embodiment of the cutting machine according to the invention. The same numbers indicated the same or equivalent parts to those of the previous embodiment. The variation lies in the different way in which alternate movement is transmitted to the three disk-shaped blades 19A, 19B, 19C supported by the rotating element 17. While in the previous case each disk-shaped blade was supported by a sleeve equipped with a feeler 67A, 67B or 67C cooperating with a single annular cam 71, in this case the sleeves that carry the shafts 55A, 55B and 55C of the blades 19A, 19B and 19C cooperate with three respective rockers 121A, 121B and 121C hinged in X to the rotating element 17 and bearing (at the opposite end from the one cooperating with the supporting sleeves of the rotating disk-shaped blades 19A, 19B, 19C) small wheels 123A, 123B and 123C cooperating with an annular cam 125 disposed coaxially around the axis A-A of rotation of the rotating element 17.

In this way each supporting sleeve of the respective blade 19A, 19B 19C and the blade itself are always controlled positively by the cam 125 along the entire rotation turn of each blade, while in the previous case the annular cam 71 could be limited to an arc of the circumference, the blades remaining free from the action of the cam along the rest of the arc and stressed in a position of maximum backward movement in relation to the direction of feed of the logs via the Belleville spring washer assembly 72A, 72B, 72C.

The solution described hereinbefore with reference to FIGS. 2 and 3 has, in relation to the solution in FIG. 4, the advantage of being able to concentrically dispose several cams 71 in an arc of circumference, even differing in profile, and to dispose feelers on the supporting sleeves of the blades 19A, 19B, 19C in a radially different position for the three blades so that the movement of each blade differs slightly from the others.

Alternatively, the radial direction of the feelers 67A, 67B, 67C associated with the single blades may be adjustable to modify the motion of the blades according to need, for example to obtain more or less pronounced advancement during cutting, in relation to faster or slower feed speeds of the rolls or logs L along the feed channels or paths.

It is understood that the drawing only shows an example provided purely as a practical example of the invention, as said invention may vary in forms and arrangements without however departing from the scope of the concept underlying the finding. Any reference numerals in the attached claims are provided for the purpose of facilitating reading in the light of the description and of the drawing and do not limit the scope of protection represented by the claims.

1-28. (canceled)

29. A sharpening unit for a rotating disk-shaped blade comprising at least one sharpening grinding wheel, a control component axially slidable in a support and moving angularly around an axis of said control component, and means for controlling angular movement of said control component in the support, wherein axial movement of the control component transmits motion to said grinding wheel which corresponds to said angular movement.

30. Sharpening unit as claimed in claim 29, wherein said control component further comprises a bushing axially slidable in said support and which moves angularly around the axis of the control component; said at least one grinding wheel being supported coaxially to said bushing; and said means for controlling the angular movement of the control component controls angular movement of the bushing in the support, wherein axial movement of the bushing and therefore of the grinding wheel correspond to said angular movement.

31. Sharpening unit as claimed in claim 29, further comprising a cam mechanism disposed between the support and said control component to produce axial translation of the control component when the control component rotates around said axis.

32. Sharpening unit as claimed in claim 31, further comprising an actuator associated with said control component, said actuator constructed and arranged to control rotatory movement of the control component around said axis.

33. Sharpening unit as claimed in claim 32, wherein said actuator is a piston-cylinder actuator.

34. Sharpening unit as claimed in claim 33, further comprising means for controlling contact pressure between the grinding wheel and the disk-shaped blade.

35. Sharpening unit as claimed in claim 34, wherein said means to control the contact pressure comprises means to control operating pressure of fluid which operates said piston-cylinder actuator.

36. Cutting machine for cutting elongated products comprising a disk-shaped blade and a sharpening unit according to claim 29, 30, 31, 32, 33, 34 or 35.

37. Cutting machine for cutting elongated products comprising at least one path for the products to be cut; at least one device for feeding the products along said path according to a direction of feed; a rotating element rotating around a main axis of rotation; on said rotating element, at least one disk-shaped blade rotating around an axis of rotation, said at least one disk-shaped blade being provided with alternate translatory motion, substantially parallel to the direction of feed; wherein the at least one disk-shaped blade moves axially in relation to the rotating element during rotation of said rotating element, and the translatory motion of the at least one disk-shaped blade is controlled so that the blade moves in a common direction with the direction of feed of the products to be cut when the blade is engaged in said products to follow feed of the products during cutting, motion in an opposite direction to the direction of feed of the products being imparted on said blade in a period of time in which the blade is disengaged from said products.

38. Cutting machine as claimed in claim 37, wherein said main axis of rotation of the rotating element and said axis of rotation of the at least one disk-shaped blade are substantially parallel to each other and to the direction of feed of the products to be cut.

39. Cutting machine as claimed in claim 37, wherein at least two disk-shaped blades are carried on said rotating element.

40. Cutting machine as claimed in claim 39, wherein each of said at least two disk-shaped blades is carried by a sleeve sliding axially in a corresponding seat of the rotating element.

41. Cutting machine as claimed in claim 40, further comprising a sharpening unit for a respective disk-shaped blade of said at least two disk-shaped blades, wherein the sharpening unit is integral with each said sleeve and translates with an alternate motion integral with a corresponding disk-shaped blade.

42. Cutting machine as claimed in claim 37, wherein each of said at least one disk-shaped blade is operated in alternate motion by a common cam component.

43. Cutting machine as claimed in claim 42, further comprising a feeler cooperating directly with said common cam component and being associated with each of said at least one disk-shaped blade.

44. Cutting machine as claimed in claim 42, wherein said common cam component transmits movement to each said sleeve via respective rocker components supported by said rotating element.

45. Cutting machine as claimed in claim 40, wherein each said sleeve includes an anti-rotation means which prevents rotation while allowing translation of the sleeve around an axis in relation to the rotating element.

46. Cutting machine as claimed in claim 41, wherein each said sharpening unit comprises at least one grinding wheel that moves from an operating position, in contact with a cutting edge of a respective disk-shaped blade of said at least two disk-shaped blades, to a non-operating position out of contact with said respective disk-shaped blade.

47. Cutting machine as claimed in claim 41, wherein each said sharpening unit comprises two grinding wheels for sharpening two sides of a cutting edge of a respective blade.

48. Cutting machine as claimed in claim 47, wherein two grinding wheels each move from a respective operating position in contact with a side of the cutting edge of the respective disk-shaped blade, to a respective non-operating position out of contact with said disk-shaped blade.

49. Cutting machine as claimed in claim 48, wherein said at least one grinding wheel moves toward or away from the cutting blade and is parallel to an axis of the at least one grinding wheel.

50. Cutting machine as claimed in claim 46, wherein each of said at least one grinding wheel is carried by a bushing axially slidable in a support integral with the sleeve of the respective blade.

51. Cutting machine as claimed in claim 50, wherein said bushing moves angularly around an axis thereof coinciding with the axis of rotation of the grinding wheel.

52. Cutting machine as claimed in claim 51, further comprising a cam mechanism which produces axial translation of the bushing when said bushing rotates around said axis, and is disposed between said support and the bushing.

53. Cutting machine as claimed in claim 50, further comprising an actuator which controls rotary movement of the bushing around said axis, said actuator being associated with each said bushing.

54. Cutting machine as claimed in claim 50, wherein said bushing has a helical groove in which a small wheel integral with said support engages.

55. Cutting machine for cutting elongated products comprising at least one path for the products to be cut; at least one device for feeding the products along said path according to a direction of feed; a rotating element rotating around a main axis of rotation; on said rotating element, at least one disk-shaped blade rotating around an axis of rotation of said blade, said blade being provided with alternate translatory motion parallel to said axis of said blade during rotation of said rotating element substantially parallel to the direction of feed; wherein each of said at least one disk-shaped blade is operated in said alternate translatory motion by a common cam component.

56. Machine as claimed in claim 55, wherein said common cam component is substantially fixed.
